(19) United States
(12) Patent Application Publication
(10) Pub. No.: US 2014/0190609 A1
(43) Pub. Date: Jul. 10, 2014

(54) TIRE CHAIN TENSION SOURCES AND STABILIZERS

(71) Applicant: Ray R. Miller, Lakewood, WA (US)

(72) Inventor: Ray R. Miller, Lakewood, WA (US)

(21) Appl. No.: 13/261,811

(22) PCT Filed: Sep. 29, 2011
(86) PCT No.: PCT/US11/01679

§ 371 Date: Feb. 10, 2014

Related U.S. Application Data
(60) Provisional application No. 61/575,293, filed on Aug. 19, 2011.

(51) Int. Cl. B60C 27/00

(52) U.S. Cl. CPC B60C 27/003
USPC 152/217; 29/428

(57) ABSTRACT

Tire chain elastic tension sources and non elastic stabilizer components for providing sources of tension for returning deflected cross chains to their natural operating positions during chain mounting and for combined action of the two devices for stabilizing a tire chain on the wheel, in operation, and acting in combination with suitably constructed tire chains to optimize chain mounting and operation.

### CROSS REFERENCES TO RELATED APPLICATIONS

PCT/US 11/01679 FILING DATE: Sep. 29, 2011

U.S. PPA App'n 61/575,293 Tire Chain Tightener and Tension Source File date 19 Aug. 2011

### FEDERALLY SPONSORED RESEARCH

Not applicable.

### SEQUENCE LISTING OR PROGRAM

Not applicable.

### BACKGROUND OF THE INVENTION

1. Field of the Invention

Tire chain tension sources to pull cross chains, deflected during mounting, into normal operating position, and stabilizer sections, to maintain position of the tire chain, in operation.

2. Prior Art

The overall objective of the invention is to replace the one hundred year old standard practice for highway truck tire chains, that is—link construction, ladder pattern chains, mounted tuck-in, roll-on method. The specific objective of the present disclosure is to provide a tension source section and chain stabilizer section for the tire chain on U.S. Pat. No. 8,162,017, Miller, to serve as a combination technology to replace the present standard. Examples of the prior art, all of the same basic concept, include: U.S. Pat. No. 953,673 A, Weed, 1910, U.S. Pat. No. 1,330,497 A, Reyburn, 1920, and U.S. Pat. No. 7,703,492, Langue, et al, and the ad hoc use of three to five common tarp straps, as chain tighteners.

Functions to be performed by the tightener, other than removal of initial chain slack, are:
resistance to centrifugal force on the chain in operation, causing “throw out” of the cross chains, from the tire tread.
resistance to chain weight imbalance and/or tensioner force imbalance.
resistance to random spikes of operating forces, such as heavy braking, cornering, or skids.

### GENERAL NATURE OF THE INVENTION

The present disclosure is intended to complete a tire chain technology based on Miller 017, which is a significant advance in tire chain technology for highway trucks, but lacks a suitable tension source for the mount-about-the-tire footprint mounting method, and the other chain tightener functions, listed above.

The instant disclosure is an optimized tension source for restoring end-of-chain cross chains, to normal operating positions, after deflection in mounting, and separately, a stabilizer section to maintain chain position in operation. The optimized tension source is too low in tension capacity to serve as a customary chain tightener for normally loaded trucks, producing normally deflected cross chains, but can be used for lightly loaded trucks causing only slightly deflected cross chains, in mounting, making the tension source adequate, as a chain tightener, for a good percentage of delivery truck chain mountings. This “good percentage” of mountings is, by its nature, a one stop mount. The stabilizer is typically more than adequate in all conditions, for essentially all mounts.

The required heavy duty chain tightener functions for all mountings other than the one stop mounts described above, are achieved by driving a short distance to a second stop in the mount, un-hooking the tension source and the side chain closure device, and re-hooking the side chain closure to a condition of a taut tire chain, and re-hooking the tension source. The tire chain then bears all of the operating forces. As stated, the stabilizer is typically adequate, for expected forces. The re-hooking is made easy by automatic migration of chain slack to the side chain closure device, during the short trip to the second stop of the mount.

Thus, the integrated combination of the 017 chain and the instant disclosure tension source and stabilizer constitute a complete tire chain technology with notable advances in truck tire chain performance. The combination provides improved performance in all ways known to compare truck tire chain usage, specifically:
for all trips, short and long.
for all tires—normal, wide base, open shoulder, aggressive tread.
for all loads—empty, light, full load.

And uniquely, the combination is able to perform several important chain functions not possible with other known chain technology:
one stop mounts.
two stop mounts.
a two stop mount to a taut chain.
adapting the mount to the trip at hand—short or long.
for special chains—
   exceptional centrifugal force control on wide base tires.
   high performance two rail dual chain.
   full seating of cross chains on open shoulder tires.

Patent 017 discloses two different methods of mounting tire chains. The present practice recommended mounting method, tuck-in, roll-on, is abandoned. The two methods defined in 017 are based on mounting about the tire footprint. 017 discloses several novel measures, both in chain manufacture and in mounting procedures, to enable a one stop chain mount under certain favorable conditions, and a two stop mount under any conditions.

The success of the combined technology is based on a high degree of functioning interaction of the two disclosures.

From 017:
eliminate roll-on mounting.
provide for improved chain-to-tire fit in both chain manufacture and in mounting procedures.

From present disclosure:
eliminate distributed slack tightening.
automatically concentrate all chain slack for easy handling.
reduce the need for some of the more extreme measures in 017 as to tension sources and slack reduction.

All chain mountings in this disclosure begin with a mount about the tire footprint. All mountings have steps of draping the chain over the tire, and attaching the inner face side chain into a loop on the tire. The standard mount continues with steps of aligning the cross chains into natural operating positions on the tread face, and attaching the outer face side chain into a loop on the tire, and driving a short distance to allow residual chain slack to migrate to the side chain closure device, and to choose a safe place for the second stop of the mount.

At the second stop, the steps are: un-hooking the tension source and the outer face side chain closure device, and re-hooking the closure device in a condition of taut chain, and re-hooking the tension source.

By definition, the one stop mount is completed at the initial travel step. The one stop mount is normally utilized only on delivery or other short haul routes. Delivery routes are especially suited to the conditions needed for a one stop mount—empty or light loaded truck is a key item.

The final alternative mounting option is that when cross chains are fully seated in shoulder grooves, or notches, the end-of-chain cross chains cannot usually be moved from their deflected positions to their normal operating positions. Thus, following the step of aligning the cross chains into the grooves or notches, the wheel is turned a quarter to a half revolution, in order to complete the mount free of interference of the tire footprint. This alternative also produces a high quality mount in two stops, just as the basic two stop mount does.

### BRIEF DESCRIPTIONS OF THE DRAWINGS

FIG. 1 Schematic view of the tension source and stabilizer of the disclosure

FIG. 2 Preferred embodiment of the disclosure

FIG. 3 Alternative embodiment of the disclosure

FIG. 4 Schematic view to illustrate slack migration

FIGS. 5 & 6 Schematic views of force interaction between tension source and stabilizer

### OBJECTIVES

Obj. 1—Maximize the applicability of a one stop mounting method of mounting a link construction tire chain, using a combination of a chain tightener with a suitably equipped chain.

Obj. 2—Provide a chain tightener with tension source attachable to suit a low chain slack mounting, or alternatively attachable to suit a high chain slack mounting.

Obj. 3—Provide a chain tension source, to correct chain slack concentrated in a narrow zone of the tire chain circumference.

Obj. 4—Provide a chain stabilizer to offset the tension of a tension source, acting on a narrow chain slack zone.

Obj. 5—Provide a tire chain tension source to be applied in incremental components of the tension source, of a nature to be readily applied under tension, manually by the user, to obtain the desired total tension capacity.

Obj. 6—Provide a tire chain tension source, consisting of one or more tension sources, of elastic elements, attachable to the outer face side chain, at or near the side member attachment device, and oriented vertically, when mounting, and provide a stabilizer, of one or more flexible non-elastic steel tension members, oriented horizontally.

### DETAILED DESCRIPTIONS OF THE DRAWINGS

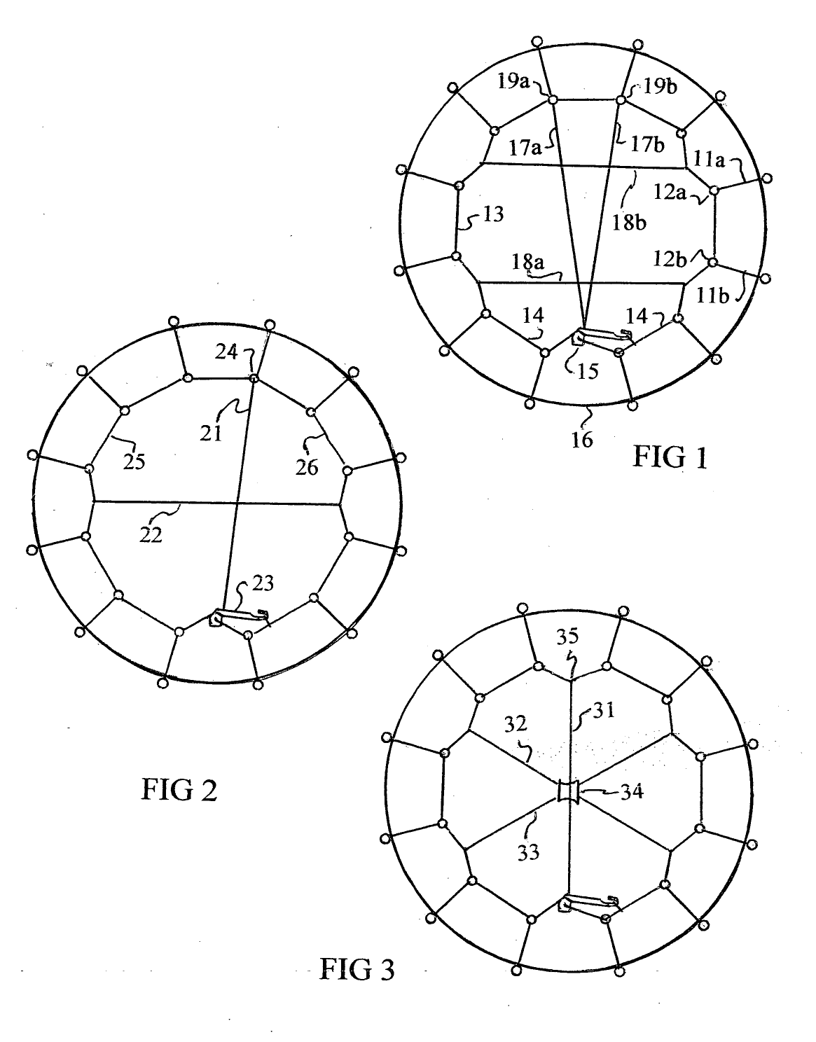

In FIG. 1, cross chains 11a and 11b have points of attachments 12a and 12b to the outer face side chain 13, thus defining segments 14 of side chain 13. The outer face side chain closure device 15 is located at the ends of the chain, which are mounted about the tire footprint 16.

The tension source has tension elements 17a and 17b hooked at or near closure device 15 and diametrically opposite on side chain 13. The stabilizer has steel chain stabilizer elements 18a and 18b attached to side chain 13 at an orientation of 90 degrees to tension source 17a and 17b. Stabilizer elements 18a and 18b will be attached to side chain 13 at a position of side chain 13 estimated to be the natural operating position of side chain 13.

Each of tension elements 17a and 17b may be in the configuration of one or two or more individual straps or loops. The only compelling reason for this is to keep the individual straps or loops below a tension capacity of about 40 pounds tension, for convenience and comfort of the user in hooking and unhooking the straps or loops.

FIG. 2 represents the preferred embodiment of the disclosure, primarily for simplicity and economy and reduced mounting effort. Any differences in performance between embodiments will be fairly small. Tension source 21 is attached vertically in the mount, beginning at outer face side chain closure 23, and stabilizer 22 is attached horizontally at side chain connections 25 and 26.

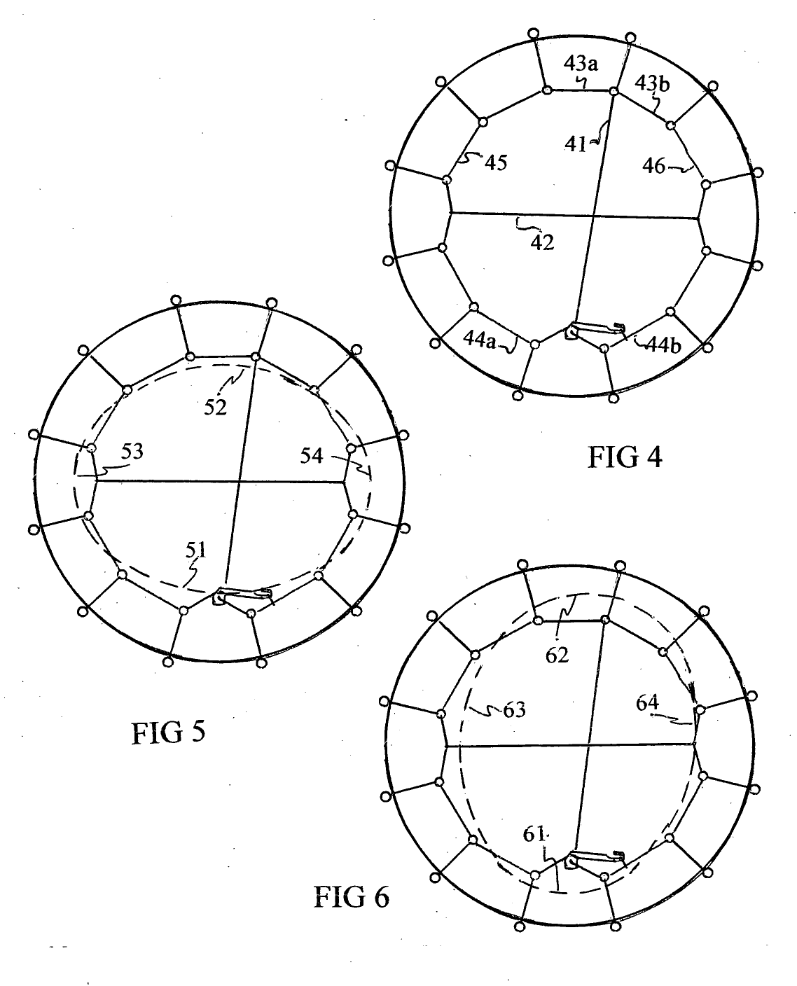

FIG. 3 displays an alternative embodiment which may have a slight advantage for safety in event of breakage of a stabilizer chain. Tension source 31 is attached vertically. Both stabilizer elements 32 and 33 pass through a loose fitting section of flexible tubing 34 which would tend to retain the stabilizer chains in event of stabilizer chain breakage.

FIG. 3 also displays an optional attachment configuration of the upper end of the tension source in which the attachment at the segment midpoint 35, as shown in FIG. 3 could be preferable for a planned one stop mounting to improve the attachment angles for the tension source, at both upper and lower attachments. Compare this view to the normal attachment at the cross chain attachment point for a two stop mount, as shown at 19a and 19b in FIG. 1 and attachment 24 in FIG. 2.

FIG 4 is used to help explain the migration of chain slack, for typical attachment of tension source 41 and stabilizer 42, from wherever slack is located on the chain circumference, to collect at the side chain segment containing the closure device, for very easy un-hooking and re-hooking to a taut chain. Because of the different angles of attachment at top and bottom, there is greater tension available at 44a and 44b, than at 43a and 43b. This differential and the friction release provided by traveling and chain flexure, causes very fast migration of chain slack “down” to the closure device, and raising the tension level in the outer face side chain 45 and 46 up to the resultant value from the tension source.

In FIGS. 5 and 6, the tendency for the effects of the tension elements on the outer face side chain, and the inner face side chain, are shown symbolically. In FIG. 5 the outer chain is pulled radially inward at 51 and 52, tending to cause an oval shape, tending outward at 53 and 54. In FIG. 6, the inner face side chain is pulled outward at 61 and 62, tending to cause an oval shape inward at 63 and 64. All of these forces in FIGS. 5 and 6 act to place the stabilizer section, such as 42 of FIG. 4, in tension.

There is a small, but historically notable benefit which may be noted on FIG. 2. The trucking industry does not know the optimum chain tension to strive for in the tire chain, during operation. With today's technology it is impractical to measure, and given a value, it would be impossible to control, due to completely random and unknown tightening conditions. Experienced users and maintenance personnel can often tell by the feel of the chain, whether it is satisfactory or “too tight” or “too loose”. This can only be called rough judgement. Control of optimum chain tension for wear control will not significantly impact control of operating forces.

The tension source can be selected by the following procedure, referring to FIG. 2, after re-hooking the closure device to a taut chain, hook a 20 pound capacity strap into the tension source position on one chain, and hook a 40 pound capacity strap into the opposite chain. Then note the comparative wear after a suitable period. Repeat the test, changing strap capacity as appropriate. That procedure will provide a very good idea of how to control the chain tension to use for operating chained up, and controlling the wear factor on your chains.

Instant disclosure provides a historic advance in tire chain technology by combining the link tire chain and the so called “tightener” function as one interacting mechanism.

I claim:

1. A tire chain tightener comprised of a tension source section and a stabilizer section, for use on a vehicle tire chain mounted about the tire-to-ground contact area of a tire, and said tire chain comprises
a generally circular, flexible side chain forming a loop on the inner face of the tire, and a like chain on the outer face of the tire, said inner face and outer face side chains each having two ends and an attachment device at one end, and
said tension source section comprises one or more elastic tension members, each having a first end, manually fastenable by hooking to the outer face side chain, at or near said side chain attachment device, and
the opposite, second ends of said tension members are attached under tension by hooking to the outer face side chain diametrically opposite the side chain attachment device, and
the tension of the tension members is transmitted to the outer face side chain, and through the cross members to the inner face side chain, and said stabilizer section comprises one or more members of flexible, non-elastic steel, such as steel chain, each manually attachable to opposite sides of the outer face side chain, and
the stabilizer section and the tension source section are generally oriented at right angles to each other, and
in an initial mounting position, with the end-of-chain space mounted about the tire-to-ground contact area, the tension source section is attached in a nominally vertical orientation, from end to end, and the stabilizer section is attached in a nominally horizontal orientation, from end to end, and
the tension from the tension source section, and the interaction of the interconnected chain parts places the stabilizer section under tension, and maintains the stability of the chain, in operation.

2. The tire chain tightener of claim 1 in which said tension source section comprises said tension members of a tension capacity and elasticity such that the user can readily hook the tension members into position manually, by comprising the tension members of individual hooked straps or loops of a tension capacity of forty pounds or less.

3. The tire chain tightener of claim 1 in combination with a tire chain having known features to utilize the capabilities of said tire chain tightener, and said tire chain is of link construction and ladder pattern, for mounting about the tire-to-ground contact area of a tire resting on the ground, and the tire chain incorporates said known features to take advantage of the tire chain tightener capabilities, including
a) a combination of a pivot lever outer face side chain attachment, and an adjustment link for positioning said pivot lever stroke and for adjusting fit of the chain to the tire, and
b) a system of adjusting the fit of the end-of-chain space to the tire-to-ground contact area of the tire, at the time of mounting the chain, thereby reducing deflection of said end-of-chain cross chains about said tire-to-ground contact area of the tire, and
facilitating un-hooking and re-hooking said side chain attachment device and said tension members.

4. The combination of the tire chain tightener and tire chain of claim 3, in which said elastic tension members always fasten the lower end at or near the outer face side chain attachment device, and the orientation of the tension members is always nominally vertical, end to end, and
the upper end attachment may vary according to the planned trip, and
if the mount is planned as a one stop mount, beginning the trip from the initial mounting position, the upper end attachment of the elastic tension members may be at the mid point of a side chain segment, midway between adjacent cross chain attachments, whereby the angles of attachment at each end of the elastic tension members will be reduced, and
if the mount is planned as a two stop mount, completing the mount following initial short travel, the upper end attachment of the tension members may be at the side chain links which are cross chain attachment points, whereby
the tension from the tension source section will be passed through to the stabilizer section more effectively.

5. A method of mounting a link construction, ladder pattern tire chain, in combination with a tire chain tightener having an elastic tension source means and a flexible, non-elastic stabilizer means, on a tire resting on the ground, the method comprising
a) draping said tire chain over said tire in a manner such that the end cross chains of the tire chain are centered on the tire-to-ground contact area, and
b) attaching the inner face side chain into a loop on the tire, and
c) manually aligning the cross chains into their natural operating positions on the tread, and
d) attaching said stabilizer means in horizontal orientation by hooking to the outer face side chain at or near the wheel center elevation in a side chain position estimated to be the natural operating position of the side chain, and
e) attaching the outer face side chain into a loop on the tire, by closing the side chain attachment device in a condition of tight side chain, and
f) attaching a tension source means in vertical orientation by hooking to the outer face side chain at or near the side chain attachment device and diametrically opposite at a side chain link which is an attachment point for a cross chain, and
g) driving the vehicle a short distance to a safe stopping place to allow any chain slack in the outer face side chain to automatically migrate to the location of the side chain attachment device, and
h) stopping the vehicle to unhook the tension source means and the side chain attachment device and re-hook the attachment device to provide a side chain taut condition, and re-hook the tension source means into position.

6. An alternative method to the mounting method of claim 5, in which following said step d) attaching a stabilizer means, remaining steps comprise temporarily attaching the outer face attachment means, driving the vehicle to turn the tire a quarter to a half a revolution, to clear the tire-to-ground contact area, and completing the mounting, in that position.

7. The chain tightener of claim 1, in combination with, and attached to, a dual tire chain mounted on dual tires, and said dual tire chain comprises cross members arrayed across the tire treads of said dual tires, whereby
after mounting the chain and a short initial drive, stopping and unhooking said said chain tightener tension members and said outer face side chain attachment device, and re-hooking the side chain attachment device to a condition of taut side chain, and re-hooking the tension members provides support against centrifugal action on said cross chains, during operation, in a very effective manner.

8. The chain tightener of claim 1, in combination with, and attached to, a wide base tire chain mounted on a tire, and said wide base tire chain is for a single wide tread tire replacing two dual tires and said tire chain comprises cross chains arrayed across the tire tread, whereby
after mounting the chain and a short initial drive, stopping and unhooking said chain tightener tension members and said outer face side chain attachment device, re-hooking the side chain attachment device to a condition of taut side chain, and re-hooking the tension members provides support against centrifugal action on said cross chains, during operation, in a very effective manner.

9. The chain tightener of claim 1, in combination with, and attached to a cable construction tire chain, mounted on a vehicle tire, whereby
during operation, the inherent control of said tightener maintains the tension level of the chain on the tire, below the critical tension level adversely affecting operation of the mounted chain, while maintaining the stability of the mounted chain.

10. The chain tightener of claim 1 in combination with, and attached to, a link construction, ladder pattern chain, mounted on a vehicle tire, said chain having each side chain attachment comprised of an open hook on one end and plain links on the other end.

11. The chain tightener of claim 1 in combination with, and attached to, a link construction, ladder pattern, wide base tire chain, mounted on a vehicle tire, said tire having a tread pattern including shoulder notches, or grooves, wide enough to fully seat the tire chain cross chains, thereby
enabling fully seated cross chains in the mount.
